(19) United States
(12) Patent Application Publication
(10) Pub. No.: US 2015/0026873 A1
(43) Pub. Date: Jan. 29, 2015

(54) TOILET CLEANER

(71) Applicants: Wendy Becker, East Sussex (GB); Glenn Frederick Mackay, East Sussex (GB)

(72) Inventors: Wendy Becker, East Sussex (GB); Glenn Frederick Mackay, East Sussex (GB)

(21) Appl. No.: 14/247,248

(22) Filed: Apr. 7, 2014

(30) Foreign Application Priority Data
Apr. 6, 2013 (GB) 13036301.1

(51) Int. Cl. E03D 9/00; B05B 7/04

(52) U.S. Cl. CPC E03D 9/005; B05B 7/0408
USPC 4/223

(57) ABSTRACT

A toilet cleaning system in which a hand held unit (28) is attached to a conduit (24) (e.g., a pipe, a hose, etc.) that is fully or in part flexible and is connected to a water supply (22). In this embodiment, a “trigger” device (30) is within the hand held unit (28) to prevent or allow the water to travel through the system. A chamber (32) is positioned within the hand held unit (28) and contains a sanitizing agent. The chamber (32) is connected to the portion of the hand held unit (34) containing the “trigger” (30) with a watertight connection (36). The water mixes with the sanitizing agent as it travels through the chamber section containing the sanitizing agent and the mixture exits at point (38) of the hand held unit either through the end of the unit or through a side (39) of the unit (28).

### BACKGROUND OF THE INVENTION

1. Field of the Invention

The present invention relates to toilet cleaner and more particularly to a system whereby pressurized water is mixed with a sanitizing agent to cleanse the bowl of a toilet pan.

2. Description of the Related Art

When residue is left on the surface of a toilet pan the removal is usually by pouring a sanitizer such as bleach onto the area, or a manual process, the most universal method being the use of an item most commonly referred to as a toilet brush. The toilet brush normally resides in a stand to contain the brush when not in use near to the toilet. In order to do its purpose of removal the brush must come into contact with the residue and the water within the toilet bowl. The brush will therefore need sanitizing. There is a likelihood that in order to be sanitized the brush will pass over other surface areas and may release through droplets of water falling from the brush contamination to those surface areas which in turn will require sanitizing.

### BRIEF SUMMARY OF THE INVENTION

Embodiments of the present invention address deficiencies of the art in respect to cleaning a toilet and provide a novel and non-obvious method and system for cleaning the toilet pan of a toilet. In an embodiment of the invention, a toilet cleaning system includes a hand held unit to dispense a liquid mixture of water and a sanitizing agent, the mixture being directed under pressure at the residue, without any contact being made with the residue with a physical object. The agent is contained within its own chamber through which the water passes through along its path of travel between the point of connection to the water supply and the point of exit of the hand held unit, mixing with the agent and forming the sanitized solution. The system eliminates any contact between the residue and a physical object and the need of sanitation to any object used and any surface that has had the risk of contamination from the object.

A toilet cleaning system in which a hand held unit (28) is attached to a conduit (24) (e.g., a pipe, a hose, etc.) that is fully or in part flexible and is connected to a water supply (22). In this embodiment, a “trigger” device (30) is within the hand held unit (28) to prevent or allow the water to travel through the system. A chamber (32) is positioned within the hand held unit (28) and contains a sanitizing agent. The chamber (32) is connected to the portion of the hand held unit (34) containing the “trigger” (30) with a watertight connection (36). The water mixes with the sanitizing agent as it travels through the chamber section containing the sanitizing agent and the mixture exits at point (38) of the hand held unit either through the end of the unit or through a side (39) of the unit (28).

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 illustrates a toilet brush next to the toilet and in its stand;

FIG. 2 illustrates a toilet brush passing over surface areas after being in use and the empty stand;

FIG. 3 illustrates the toilet cleaning system at rest according to the invention with a connection between the water supply pipe and a flexible water hose which is in turn connected to the hand held unit and the unit is at rest in its cradle;

FIG. 4 illustrates the toilet cleaning system in use according to the invention with a connection between the water supply pipe and a flexible water hose which in turn is connected to the hand held unit from which the mixture exits and the empty cradle; and

FIG. 5 illustrates the toilet cleaning system.

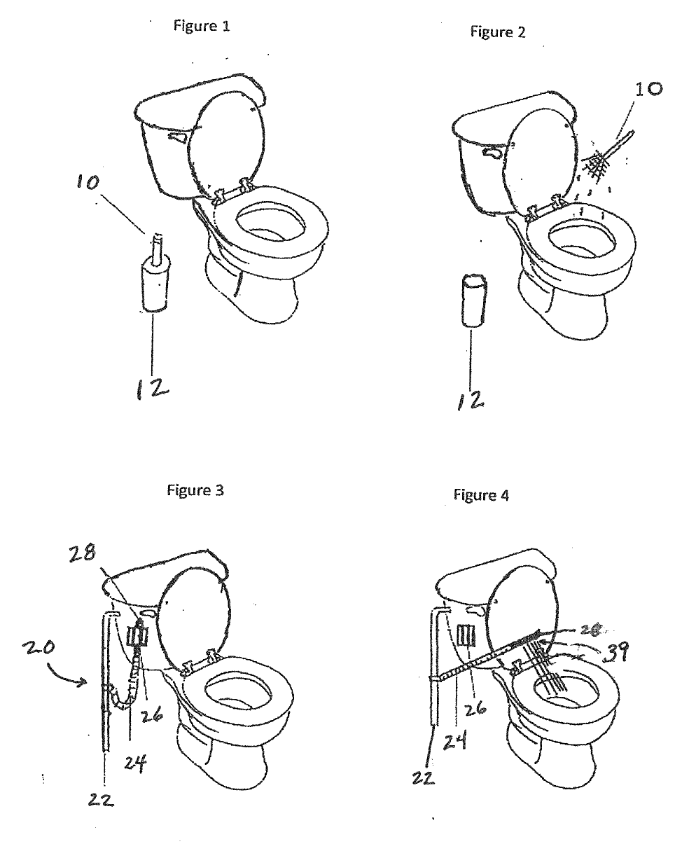

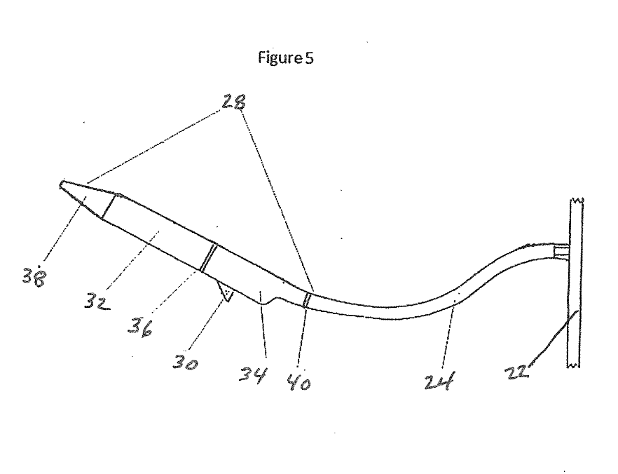

### DETAILED DESCRIPTION OF THE INVENTION

Embodiments of the invention provide for a toilet cleaning system that includes a hand held unit to dispense a liquid mixture of water and a sanitizing agent, the mixture being directed under pressure at the residue, without any contact being made with the residue with a physical object. The agent is contained within it's own chamber through which the water passes through along it's path of travel between the point of connection to the water supply and the point of exit of the hand held unit, mixing with the agent and forming the sanitized solution. The system eliminates any contact between the residue and a physical object and the need of sanitation to any object used and any surface that has had the risk of contamination from the object.

Preferably the system obtains water via a connection to the water supply that feeds the toilet cistern using main pressure.

Preferably the system has one or more means to prevent or allow the water to travel through the system.

Preferably the system has a means to prevent or allow the water to travel through the system positioned within the hand held unit.

Preferably the system has a flexible pipe/hose connection at a point between the hand held unit and the point of connection to the pressurized water supply.

Preferably the system has a chamber to contain a sanitizing agent placed in line with the water flow path at a point between the connection to the pressurized water supply and the point of exit from the hand held unit.

Preferably the system has a chamber to contain the sanitizing agent or agents that is detachable in a manner to allow replenishment of the agent or agent.

Preferably the system has a chamber to contain the sanitizing agent or agents that is positioned within the hand held unit.

Preferably the system has a control or structure to adjust the pressure of the mixture exiting the hand held unit.

Preferably the system has a control or structure to adjust the flow pattern of the mixture exit in the hand held unit.

Preferably the system has a control or structure to adjust the angle of projection of the mixture exiting the hand held unit.

Preferably the system has a control or structure to adjust the pressure at any point within the system utilizing the Venturi effect.

Preferably the system has a means of retaining the hand held unit when not in use.

In one embodiment, a hand held unit (28) is attached to a conduit (24) (e.g., a pipe, a hose, etc.) that is fully or in part flexible and in turn is connected to a water supply (22). In this embodiment, a “trigger” device (30) is within the hand held unit (28) to prevent or allow the water to travel through the system. A chamber (32), in this embodiment, is positioned within the hand held unit (28) and contains a sanitizing agent. The chamber (32) is connected to the portion of the hand held unit (34) containing the “trigger” (30) with a watertight connection (36). The water mixes with the sanitizing agent as it travels through the chamber section containing the sanitizing agent and the mixture exits at point (38) of the hand held unit either through the end of the unit or through a side (39) of the unit (28) as shown in FIG. 4). A “‘trigger” or stop cock device (30) is placed between the supply of water connection (22) and the chamber (32) to stop the flow of water when separating the chamber from the system in order to replenish the sanitizing agent or agents.

In another embodiment, the hand held unit (28) is attached to a conduit (24) (e.g., a pipe, a hose, etc.) by use of a swivel connector 40 which allows the hand held unit to revolve within swivel connector 40 in therefore not twist the hose or pipe as may happen with a fixed connector.

Having thus described the invention of the present application in detail and by reference to embodiments thereof, it will be apparent that modifications and variations are possible without departing from the scope of the invention defined in the appended claims as follows:

We claim:

1. A system to clean the surface of a toilet pan, the system comprising:
a hand held unit to dispense a liquid mixture of water and a sanitizing agent the water being under pressure and making contact with the agent within the system; and,
the agent being within its own carrier and the water being obtained from a main water feed pipe.

2. A system according to claim 1, in which the system obtains its water by a connection to the pressurized water supply that feeds the toilet cistern.

3. A system according to claim 1, in which there are at least one means to control the flow of the water through the system.

4. A system according to claim 3, in which the at least one means to control the flow of the water through the system is located within the hand held unit.

5. A system according to claim 1, further comprising a flexible hose swivel connection at a point between the hand held unit and the point of connection to the pressurized water supply.

6. A system according to claim 1, further comprising a chamber to contain a sanitizing agent placed in line of the water flow path and positioned between the connection of the pressurized water supply and the point of exit from the hand held unit.

7. A system according to claim 6, in which a chamber to contain the sanitizing agent or agents is compartmental, where each compartment designed to contain an agent and each compartment being placed either singularly or as a multiple in line with the water flow path.

8. A system according to claim 7, in which a chamber containing the sanitizing agent or agents is detachable in a manner to allow replenishment of the agent or agents.

9. A system according to claim 8, in which the chamber to contain the agent or agents is situate within the hand held unit.

10. A system according to claim 1, in which the system has a control to adjust the pressure of the mixture exiting the hand held unit.

11. A system according to claim 10, in which the system has a control to adjust the pressure of the mixture exiting the hand held unit at any point within the system by utilizing the Venturi effect.

12. A system according to claim 1, in which the system has a control to adjust the flow Pattern of the mixture exiting the hand held unit.

13. A system according to claim 1, in which the system has a control to adjust the angle of projection of the mixture exiting the hand held unit.

14. A system according to claim 1, in which the system has a means of retaining the hand held unit when not in use.
